(19) United States
(12) Patent Application Publication
(10) Pub. No.: US 2022/0355258 A1
(43) Pub. Date: Nov. 10, 2022

(54) POWDER MIXING SYSTEM, AND POWDER MIXING METHOD

(71) Applicant: Hitachi, Ltd., Tokyo (JP)

(72) Inventors: Jun TANAKA, Tokyo (JP); Tomonari MISAWA, Tokyo (JP); Yusuke KAGA, Tokyo (JP); Yoshiki YONAMOTO, Tokyo (JP)

(21) Appl. No.: 17/764,595

(22) PCT Filed: Oct. 9, 2020
(86) PCT No.: PCT/JP2020/038363

§ 371 Date: Mar. 29, 2022

(30) Foreign Application Priority Data
Oct. 9, 2019 (JP) 2019-185645

(51) Int. Cl. B01F 29/62; B01F 23/60; B01F 35/213; G01N 21/85

(52) U.S. Cl. CPC B01F 29/62; B01F 23/69; B01F 35/213; G01N 21/85; G01N 2021/8405

(57) ABSTRACT

A powder mixing system and method improves productivity of a final product by reducing time required for completion of mixing. The powder mixing system includes a mixing vessel provided with a rotating shaft for mixing multiple kinds of powder, a rotating machine for rotating the mixing vessel by means of the rotating shaft, an image photographing device for acquiring an image of the powder in a mixing process, and a computer. The mixing vessel includes a window through which the image of the powder is photographed. The computer has a function of detecting that the mixing vessel is located at a predetermined position. The image photographing device acquires the image of the powder through the window of the mixing vessel located at the predetermined position. The computer estimates a mixing state of the powder based on the acquired image of the powder.

### TECHNICAL FIELD

The present invention relates to a powder mixing system and a powder mixing method for mixing multiple kinds of powder materials.

### BACKGROUND ART

Various kinds of materials, compositions, and particle substances are mixed into powder mixture as aggregated particulate solid substances for use in the fields of powder metallurgy, pharmaceutical formulation, food, and the like. The mixing state of the powder mixture including multiple kinds of powder materials affects quality of the final product manufactured using the powder mixture. Accordingly, it is essential to bring the respective materials into sufficient homogeneous mixing state in the powder mixing process. A mixing degree as the value for expressing the mixing state is measured to provide the index for determining whether the mixture has reached the homogeneous state. Based on the mixing degree, quality optimization and quality control of the final product have been performed.

The following explanation is quoted from the abstract of PTL 1. That is, “In order to secure the stable evaluation index on homogeneity in the mixing state of the mixture”, “the device is provided for evaluating homogeneity of the mixture including multiple kinds of materials. The device includes an input section for inputting input information indicating a physical value of each of multiple kinds of materials as compositions of the mixture, or the number of the multiple kinds of materials; a calculation section for calculating an entropy indicating a degree of dissociation between a first mixture ratio and a second mixture ratio; and an output section for outputting a calculation result of the calculation section. The first mixture ratio indicates a ratio of mixture among multiple kinds of materials used for mixing, and the second mixture ratio indicates the ratio of mixture among the respective materials as compositions of an inspection area formed as a part of the mixture having the multiple kinds of materials brought into the mixing state.”

### CITATION LIST

### Patent Literature

PTL 1: Japanese Patent Application Laid-Open No. 2018-72158

### SUMMARY OF INVENTION

### Technical Problem

The device for evaluating homogeneity as disclosed in PTL 1 is configured to extract a part of the powder in the mixing process from the mixing vessel, and to obtain quantity or mass of the powder based on an acquired image of the extracted powder. Accordingly, much time is required for completion of mixing, resulting in low productivity of the final product.

It is an object of the present invention to provide the powder mixing system, and the powder mixing method for improving productivity of the final product by reducing the time required for completion of mixing.

### Solution to Problem

In order to accomplish the object, the powder mixing system according to the present invention includes a mixing vessel provided with a rotating shaft for mixing multiple kinds of powder, a rotating machine for rotating the mixing vessel by means of the rotating shaft, an image photographing device for acquiring an image of the powder in a mixing process, and a computer. The mixing vessel includes a window through which the image of the powder is photographed. The computer has a function of detecting that the mixing vessel is located at a predetermined position. The image photographing device acquires the image of the powder through the window of the mixing vessel located at the predetermined position. The computer estimates a mixing state of the powder based on the acquired image of the powder.

A powder mixing method is provided for the powder mixing system including a mixing vessel provided with a rotating shaft for mixing multiple kinds of powder, a rotating machine for rotating the mixing vessel by means of the rotating shaft, an image photographing device for acquiring an image of the powder in a mixing process, and a computer. When the computer detects that the mixing vessel rotated by the rotating machine is located at a predetermined position, the image photographing device acquires a digital RGB color image of the powder in the mixing process. The computer extracts an image of specific powder from the powder including multiple powder materials, calculates a mixing degree based on an existence probability of the specific powder in an overall image of powder mixture, and allows mixing to be terminated when the mixing degree satisfies a predetermined condition.

### Advantageous Effects of Invention

The present invention provides the powder mixing system, and the powder mixing method, which allow reduction in overall mixing time and improvement in the final product productivity by directly estimating the powder mixing state in the mixing process instantly.

### BRIEF DESCRIPTION OF DRAWINGS

FIG. 1 is a sectional view of a powder mixing system according to Example 1 of the present invention.

FIG. 2 is a sectional view of the powder mixing system according to Example 1 of the present invention in the state where a mixing vessel has been rotated.

FIG. 3 is a sectional view of the powder mixing system according to Example 1 of the present invention, representing communication between an image photographing device and a computer.

FIG. 4 is a flowchart representing a powder mixing method.

FIG. 5 shows an image of powder mixture photographed by the image photographing device.

FIG. 6 is a graph representing a mixing degree of copper powder with respect to mixing time.

FIG. 7 is a graph representing a mixing degree of graphite powder with respect to the mixing time.

FIG. 8 is a sectional view of a powder mixing system according to Example 2 of the present invention.

FIG. 9 is a sectional view of the powder mixing system according to Example 2 of the present invention, representing communication between an image photographing device and a computer.

### DESCRIPTION OF EMBODIMENTS

Embodiments according to the present invention will be described referring to FIGS. 1 to 9.

### EXAMPLE 1

FIG. 1 is a sectional view of a powder mixing system according to this example.

The powder mixing system of this example includes a mixing vessel 1 provided with a rotating shaft 2 for mixing multiple kinds of powder 7, a rotating machine (not shown) for rotating the mixing vessel 1 by means of the rotating shaft 2, an image photographing device 5 for acquiring an image of the powder in the mixing process, and a computer 8.

The mixing vessel 1 has a substantially V-like shape having a powder discharging port 4 disposed on the bottom part. A powder charging port 3 is disposed on a top end of one of forked parts, and an observation window and a window frame 6 are attached to a top end of the other forked part. The window frame 6 supports an outer periphery of the observation window through which the image of the powder 7 is photographed, and is detachably attached to the mixing vessel 1. A lid is detachably attached to the powder charging port 3 so as to be opened and closed. The powder mixing system of this example allows the lid attached to the powder charging port 3 on one end side and the window frame 6 on the other end side to be switched between each other. For example, if the operation space at one end side is too limited to allow charging of the powder 7 from the one end side, it is possible to dispose the observation window on the top end at the one end side and the powder charging port 3 on the top end at the other end side. The powder charging port 3 and the observation window are provided on the top ends of the forked parts, respectively, which secure relatively wider openings. This allows the powder to be easily charged and observed in a wider range.

The mixing vessel 1 is brought into a stationary state where the powder charging port 3 is located at the upper position as illustrated in FIG. 1 for charging the powder 7. After the powder 7 is charged and the lid is closed, the mixing vessel 1 is rotated by the rotating machine for reversing the position of the powder discharging port 4 upside down repeatedly so that the powder 7 in the mixing vessel 1 is gradually mixed. The image photographing device 5 can be fixed to the window frame 6. The fixed image photographing device 5 is operated to photograph the powder mixture in the mixing vessel 1 through the observation window.

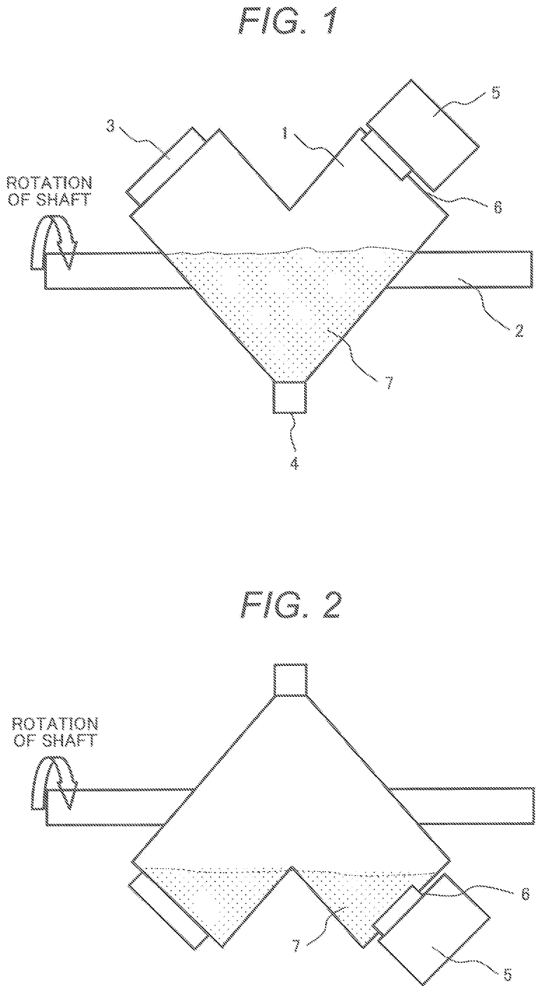

When the image photographing device 5 is located at the upper position from where the inside of the mixing vessel 1 is photographed from above as illustrated in FIG. 1, the powder 7 located at the lower position by gravity is spaced apart from the image photographing device 5. Additionally, light particles constituting the powder 7 cover the region around its upper surface. Those factors may deteriorate accuracy in measurement of the mixing state. On this account, the inside of the mixing vessel 1 is photographed in the state where the image photographing device 5 is located at the lower position as illustrated in FIG. 2. The image can be acquired from the position closer to the powder 7, resulting in improved measurement accuracy.

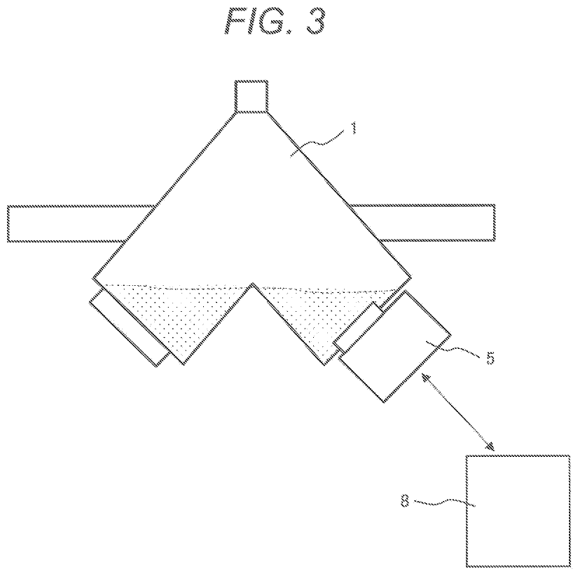

As FIG. 3 illustrates, the image photographing device 5 is communicable with the computer 8 through transmission. Since the image photographing device 5 of this example is rotated together with the mixing vessel 1 for making the overall powder mixing system compact, communication through wireless transmission is required. The computer 8 has a function of detecting that the mixing vessel 1 is located at a predetermined position, specifically, the image photographing device 5 is located at the lower position. The image photographing device 5 may be configured to photograph the image at a moment when the image photographing device 5 reaches the lower position while being rotated together with the mixing vessel 1. Alternatively, the image may be photographed by the image photographing device 5 located at the lower position while suspending the rotating motion of the mixing vessel 1. The computer 8 estimates the mixing state of the powder 7 based on the powder image received from the image photographing device 5.

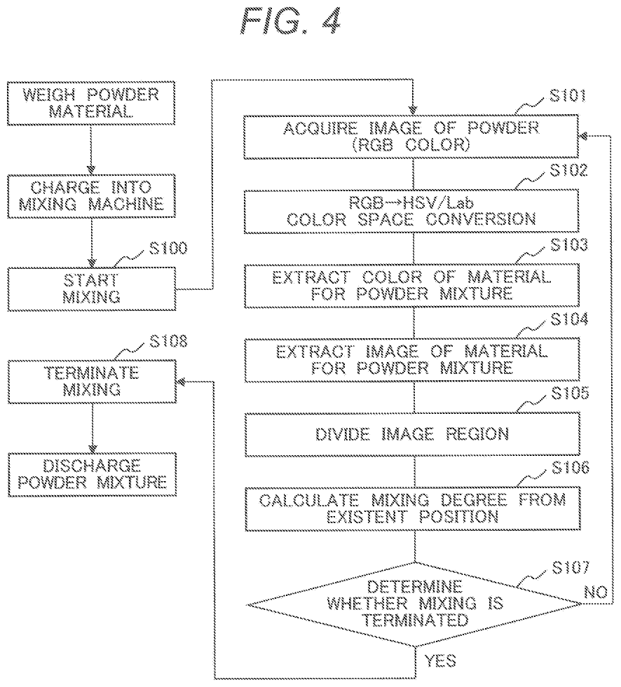

The method of mixing the powder 7 will be described referring to FIG. 4. FIG. 4 is a flowchart representing the method of mixing the powder 7.

A predetermined weight of a part of the powder 7 including multiple kinds of materials is extracted so that the extracted part of the powder 7 is charged into the mixing vessel 1 from the powder charging port 3. Upon start of mixing in step S100, the mixing vessel 1 is rotated. When the computer 8 detects that the mixing vessel 1 rotated by the mixing machine is located at a predetermined position in step S101, the image photographing device 5 acquires a digital RGB color image of the powder 7 in the mixing process through the observation window. The information of the acquired RGB color image is wirelessly transmitted to the computer 8. The computer 8 executes the image processing for extracting an image of specific powder from the one including multiple kinds of powder materials. Specifically, in step S102, the RGB (red, green, blue) color information of the overall image of the powder mixture is converted into HSV (hue, saturation, value) color information or CIE-L*a*b* color information. Then in step S103, the HSV color information or the like, which is unique to the specific powder 7, is extracted. The pixel position of the specific powder 7 in the overall image is then extracted (step S104). The overall image is divided into the arbitrary number of segments (step S105). The mixing degree is calculated using the pixel number of the specific powder 7 existing in the single divided image segment (step S106). The larger the number of divided segments becomes, the higher the accuracy in estimation of the mixing state becomes.

The following formula will be used for obtaining the mixing degree of the powder 7 based on the existence probability of the specific powder 7 in the overall image.

$$S = - {\sum }_{j = 1}^{M} {\sum }_{i = 1}^{C} [ Pj , c ln Pj , c ] \qquad [ Formula 1 ]$$

The term S denotes the mixing degree of the powder 7, the term C denotes the pixel number relating to the specific powder 7 in the overall image, the term M denotes the number of divided segments of the overall image, and the term Pj,c denotes the existence probability with respect to j, C.

As the mixing proceeds, randomness in the overall image of the powder 7 is made larger so that the mixing degree is gradually increased to approach the value 1. The upper limit value of the mixing degree, that is, the mixing degree in an actually possible homogeneous mixing state is below 1.

In step S107, it is determined whether the mixing degree satisfies a predetermined condition. If the mixing degree satisfies the predetermined condition, the mixing process is terminated in step S108. The powder mixture is then discharged from the powder discharging port 4. The specific method of determination in step S107 may be implemented as described below. If the difference from the preceding mixing degree becomes equal to or smaller than the predetermined value, which indicates the stabilized mixing state, it is determined that the mixing process is to be terminated.

In this example, the mixing state of the powder 7 can be estimated only from image information of the powder 7 in the mixing process without requiring the initial information on the specific mixing ratio of the powder 7 before mixing. The mixing state can be directly estimated instantly using the image photographing device 5 without extracting a part of the powder 7 in the mixing process from the mixing vessel 1. This makes it possible to reduce the overall mixing time and to improve the production efficiency of the final product subsequent to the mixing process.

The actual mixing result utilizing the powder mixing system of this example will be described. In this case, the mixing degree is calculated by photographing the mixing state of the iron-based powder mixture to be used for powder metallurgy of the ferroalloy material. The iron-based powder mixture to be used in this case included four kinds of powder materials of atomized iron powder, electrolytic copper powder, graphite, and zinc stearate. The atomized iron powder is grayish-colored, the electrolytic copper powder is reddish-colored, the graphite is blackish-colored, and the zinc stearate is whitish-colored.

Firstly, 97 wt. % iron, 1 wt. % electrolytic copper powder, 1 wt. % graphite powder, and 1 wt. % zinc stearate were weighed, and the weighed materials were charged into the V-shaped mixing vessel 1 of the powder mixing system to start mixing. The image of the powder mixture in the mixing process with respect to the mixing time was photographed.

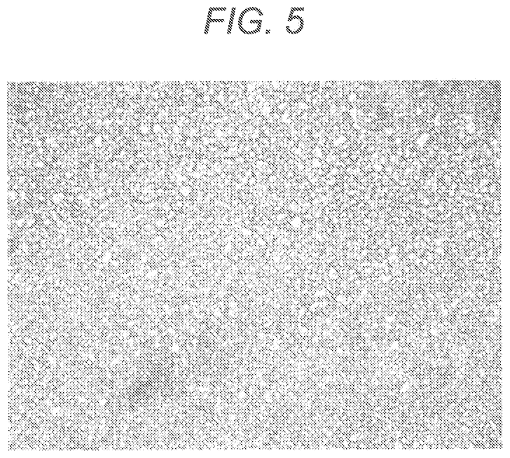

FIG. 5 shows an image of the powder mixture photographed by the image photographing device 5 having the pixel size set to 3.5 μm after an elapse of 0.03 minutes from the start of mixing. As in FIG. 5, at the mixing time of 0.03 minutes, the mixture of four kinds of powder materials is in the mixing state in the presence of segregation.

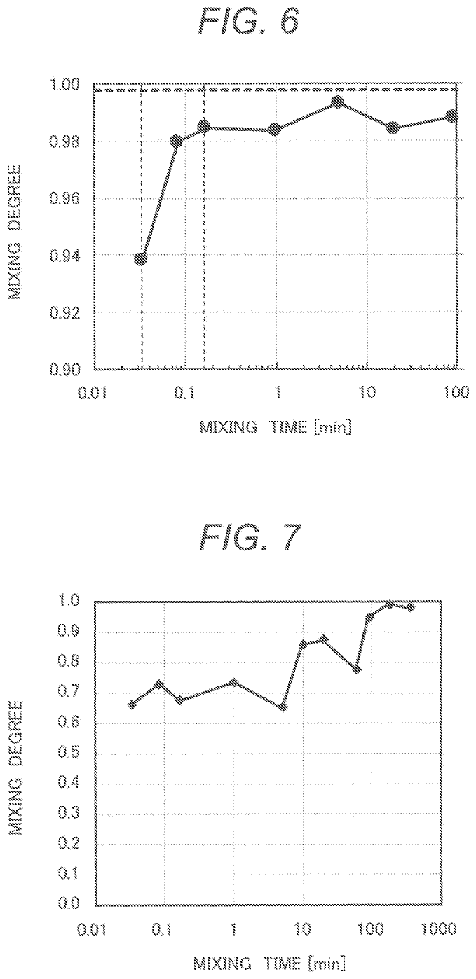

Calculation of the mixing degree will be described while focusing on the electrolytic copper powder. The computer 8 extracts the reddish color information unique to the copper powder from the overall image which has been converted into the color information such as HSV. The image of the copper powder is extracted to calculate its mixing degree. FIG. 6 is a graph representing a mixing degree of the copper powder with respect to the mixing time. In the process as indicated by FIG. 6, the mixing degree becomes higher dependent on the mixing time, leading to saturation.

Calculation of the mixing degree will be described while focusing on the graphite powder material. The computer 8 extracts the color information with saturated luminance from the overall image which has been converted into the color information such as HSV. The image of the graphite powder is extracted to calculate its mixing degree. FIG. 7 is a graph representing a mixing degree of the graphite powder with respect to the mixing time. The graphite powder pulverized in the mixing process into an atomized state adheres to the surface of the iron powder and the copper powder. As the mixing proceeds, the bright region is reduced. Accordingly, the mixing degree of the graphite powder can be calculated without the hue information.

### EXAMPLE 2

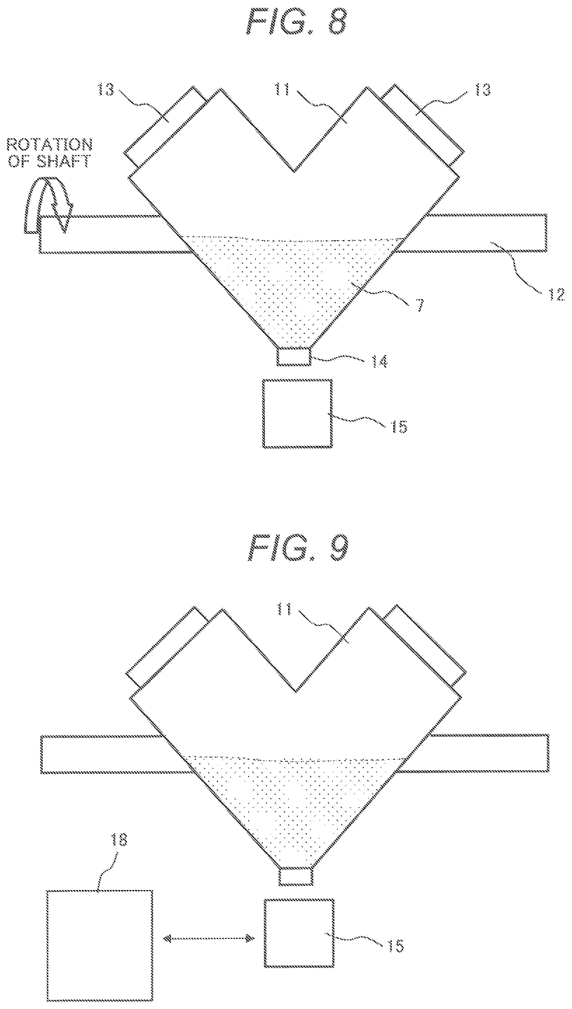

FIG. 8 is a sectional view of a powder mixing system according to this example. The powder mixing system of this example allows a window frame 16 and a lid of a powder discharging port to be switchable between each other. An image photographing device 15 of this example is disposed along the line which intersects a rotating shaft 12 at right angles, and passes through the powder discharging port. This example allows an image to be photographed at the center of the bottom of the mixing vessel 1 on which the powder discharging port is disposed. This makes it possible to improve accuracy of estimating the mixing state. Unlike Example 1, the image photographing device 15 of this example is not rotated together with the mixing vessel 1. This allows communication between the image photographing device 15 and a computer 18 through wired transmission. This also allows communication between the image photographing device 15 and the computer 18 through wireless transmission.

The powder mixing system of this example is configured to photograph the inside of the mixing vessel 11 when the window frame 16 is located to face the image photographing device 15, that is, the window frame 16 is located in a vertically downward direction. Powder charging ports 13 are disposed on both top ends of the forked parts. This example allows estimation of the mixing state only by photographing the image of the powder 7 while operating the mixing without extracting the powder 7 from the mixing vessel 11.

The present invention includes various modifications without being limited to Examples 1 and 2 as described above. The first and Example 2s have been described in detail for readily understanding of the present invention, which are not necessarily limited to the one equipped with all structures as described above. It is possible to replace a part of the structure of one example with the structure of another example. The structure of the one example may be provided with an additional structure of another example. It is further possible to add, remove, and replace the other structure to, from and with a part of each structure of the respective examples.

### REFERENCE SIGNS LIST

1, 11 . . . mixing vessel,

2, 12 . . . rotating shaft,

3, 13 . . . powder charging port,

4, 14 . . . powder discharging port,

5, 15 . . . image photographing device,

6, 16 . . . window frame,

7 . . . powder,

8, 18 . . . computer

1. A powder mixing system comprising a mixing vessel provided with a rotating shaft for mixing multiple kinds of powder; a rotating machine for rotating the mixing vessel by means of the rotating shaft; an image photographing device for acquiring an image of the powder in a mixing process; and a computer,
wherein the mixing vessel includes a window through which the image of the powder is photographed;
the computer has a function of detecting that the mixing vessel is located at a predetermined position;
the image photographing device acquires the image of the powder through the window of the mixing vessel located at the predetermined position; and
the computer estimates a mixing state of the powder based on the acquired image of the powder.

2. The powder mixing system according to claim 1,
wherein a window frame including the window of the mixing vessel, and a lid of a powder charging port disposed on the mixing vessel are switchable between each other; and
the image photographing device fixable to the window frame is communicable with the computer through wireless transmission.

3. The powder mixing system according to claim 1,
wherein a window frame including the window of the mixing vessel, and a lid of a powder discharging port disposed on the mixing vessel are switchable between each other; and
the image photographing device is disposed along a line which intersects the rotating shaft at right angles, and passes through the powder discharging port.

4. The powder mixing system according to claim 3,
wherein the image photographing device is communicable with the computer through wired transmission.

5. The powder mixing system according to claim 3,
wherein the image photographing device is communicable with the computer through wireless transmission.

6. A powder mixing method for a powder mixing system including a mixing vessel provided with a rotating shaft for mixing multiple kinds of powder, a rotating machine for rotating the mixing vessel by means of the rotating shaft, an image photographing device for acquiring an image of the powder in a mixing process, and a computer,
wherein when the computer detects that the mixing vessel being rotated by the rotating machine is located at a predetermined position, the image photographing device acquires a digital RGB color image of the powder in the mixing process; and
the computer extracts an image of specific powder from the powder including multiple powder materials, calculates a mixing degree based on an existence probability of the specific powder in an overall image of powder mixture, and allows mixing to be terminated when the mixing degree satisfies a predetermined condition.

7. The powder mixing method according to claim 6,
wherein the computer converts RGB color information of the overall image of the powder mixture into HSV color information or CIE-L*a*b* color information, extracts a pixel position of the specific powder in the overall image of the powder mixture based on the HSV color information or the CIE-L*a*b* color information, calculates the mixing degree using a pixel number of the specific powder existing in a single divided image derived from dividing the overall image of the powder mixture, and allows the mixing to be terminated when a difference from a precedingly calculated mixing degree becomes equal to or smaller than a predetermined value.
